(19) United States
(12) Patent Application Publication
(10) Pub. No.: US 2006/0271389 A1
(43) Pub. Date: Nov. 30, 2006

(54) PAY PER PERCENTAGE OF IMPRESSIONS

(75) Inventor: Joshua T. Goodman, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/279,285

(22) Filed: Apr. 11, 2006

Related U.S. Application Data
(63) Continuation-in-part of application No. 11/158,174, filed on Jun. 21, 2005.
Application No. 11/158,174 is a continuation of application No. 11/141,307, filed on May 31, 2005.

(51) Int. Cl. G06Q 99/00

(52) U.S. Cl. 705/1

(57) ABSTRACT

An advertisement sales system comprises a receiver component that receives a request to purchase impressions on at least one of web pages and application programs based at least in part on one of an exact and approximate keyword match. A sales component sells a percentage of all such impressions to an initiator of the request. For instance, an approximate keyword match can be a match of one of a prefix and a suffix of a phrase.

### CROSS REFERENCE TO RELATED APPLICATIONS

This application is a continuation in part of U.S. patent application Ser. No. 11/158,174, filed on Jun. 21, 2005, and entitled POSTED PRICE MARKET FOR ONLINE SEARCH AND CONTENT ADVERTISEMENTS, which is a continuation of U.S. patent application Ser. No. 11/141,307, filed on May 31, 2005, and entitled POSTED PRICE MARKET FOR ONLINE SEARCH AND CONTENT ADVERTISEMENTS. The entireties of these applications are incorporated herein by reference.

### BACKGROUND

Advancements in networking and computing technologies have enabled transformation of computers from low performance/high cost devices capable of performing basic word processing and computing basic mathematical computations to high performance/low cost machines capable of a myriad of disparate functions. For example, a consumer level computing device can be employed to aid a user in paying bills, tracking expenses, communicating nearly instantaneously with friends or family across large distances by way of email or instant messaging, obtaining information from networked data repositories, and numerous other functions/activities. Computers and peripherals associated therewith have thus become a staple in modern society, utilized for both personal and business activities.

The Internet in particular has provided users with a mechanism for obtaining information regarding any suitable subject matter. For example, various web sites are dedicated to posting text, images, and video relating to world, national, and/or local news. A user with knowledge of a Uniform Resource Locator (URL) associated with one of such web sites can simply enter the URL into a web browser to be provided with the web site and access content thereon. Another conventional manner of locating desired information from the Internet is through utilization of a search engine. For instance, a user can enter a word or series of words into a search field and thereafter initiate the search engine (e.g., through depression of a button, one or more keystrokes, voice commands, . . . ). The search engine then utilizes search algorithms to locate web sites or files related to the word or series of words entered by the user into the search field, and the user can then select one of the web sites returned by the search engine to review content therein.

As more and more people have begun to utilize the Internet, it has become apparent that revenue opportunities exist for small and large businesses alike. For instance, many retail companies utilize the Internet to sell goods online, thereby reducing costs associated with managing and maintaining a store location, providing an ability to centralize inventory, and various other similar benefits that result in decreased costs that are passed on to customers. Given this increased use of the Internet for generating business and/or revenue, it has also become apparent that the Internet can be utilized as an advertising mechanism. In one example, an individual who enters the term “flower” into a search engine may be interested in purchasing flowers—thus, it is beneficial for a company that sells flowers to advertise to that user at the point in time that the user is searching for the aforementioned term. Oftentimes users will see the advertisements and click on such advertisements to purchase flowers, thereby creating business for the flower retailer. Furthermore, the search engine is provided with additional revenue by selling advertisement space for a particular period of time to the flower retailer when the term “flower” is utilized as a search term. In a similar example, a sporting goods company may wish to display advertisements on a web site related to sports, and can purchase advertising space for a limited amount of time on the web site. Again, the buying and selling of advertising space can lead to increased revenue for an owner of the web site as well as the advertiser.

Conventionally, a purchaser of advertising space pays the host of such space upon either display (impression) of the advertisement (after a keyword or set of keywords has been entered into a search engine) or upon a user selecting a displayed advertisement. This payment model, however, is subject to fraud. In a pay per impression example, an advertiser agrees to pay a certain amount per impression, for a certain keyword, perhaps up to a maximum total price. The price may be determined through an auction, negotiation, or other suitable scheme. A competitor to the advertiser may generate false searches for the keyword in order to defraud the advertiser, such that the advertiser's budget is exhausted or the advertiser's return on investment is reduced below profitability. In a pay per click example, an individual or entity can defraud an advertiser by frequently clicking on an advertisement (with no intent to buy), thus exhausting the budget of the advertiser. A pricing system or method that adjusts price or positioning of advertisements based at least in part upon click-through rates is also subject to fraud. For instance, a competitor may undertake impression fraud to lower the advertiser's click-through-rate.

### SUMMARY

The following presents a simplified summary in order to provide a basic understanding of some aspects of the claimed subject matter. This summary is not an extensive overview and is not intended to identify key/critical elements or to delineate the scope of the claimed subject matter. Its sole purpose is to present some concepts in a simplified form as a prelude to the more detailed description that is presented later.

A common problem with search advertising is “click fraud.” Advertisers may seek to defraud a competitor by clicking on their ad. This may exhaust the competitor's budget or lower his return on investment. Another problem is “impression fraud.” In some systems, rather than selling clicks, a search engine or other provider sells impressions, charging advertisers for each impression shown. An advertiser might try to generate impressions on a competitor, such as by searching for terms used by the competitor, without generating clicks, exhausting the competitor's budget, or lowering his return on investment.

To alleviate concerns associated with impression fraud and/or click fraud, advertising space can be sold as a percentage of page views that will include purchased advertising space. In a specific example, an advertiser can purchase impressions on ten percent of all search pages that are generated through utilization of a particular search term. Selling impressions in such a manner can mitigate occurrence of both click fraud and impression fraud taken upon a purchaser of the impressions as well as a seller of such impressions, particularly if the impressions (while keeping with the purchased percentages) are displayed at random. More particularly, a pattern should not exist, as an individual intending to defraud an advertiser or impression provider can utilize fake searches if a pattern of display can be discerned. If the advertisements are displayed truly at random, e.g. as a percentage of total impressions, then an advertiser cannot defraud a competitor, since no matter how many fraudulent impressions or clicks are generated, the percentage of total non-fraudulent impressions remains the same and there is no charge per click.

To render this aspect more robust, percentage information can vary depending upon where in a search a purchased term appears. For instance, a purchased term that appears as the entirety of a search string can be associated with a first percentage, the purchased term can be associated with a second percentage dependent upon location of the term within a search string if such term is not the entirety of the search string, etc. Any suitable manner of pricing search terms and allocating percentages associated with such terms is contemplated and intended to fall under the scope of the hereto appended claims. Furthermore, this manner of selling impressions based upon percentages of page views that will display the impressions can be utilized for content pages and applications as well as search pages.

Furthermore, percentages of impressions can be sold based upon exact matches, broad matches, and/or combinations thereof. In traditional broad match searches, any search phrase containing a keyword (and possibly other words as well) is sold, and a percentage of all such matches can be sold. However, if for any word A x % of the broad matches is sold, more than 100-x % cannot be sold for any word B, because searches might be of the form AB. Accordingly, to maximize revenue, a different sales type may be used, such as a prefix match or a suffix match. For example, with respect to prefix matching, up to 100% of matches of phrases starting with A can be sold and up to 100% of matches of phrases starting with B can be sold. This notion can be extended to multiple word prefixes, e.g. selling up to 100% of matches of phrases starting with “C D.”

While the claimed subject matter relates to selling impressions of search terms, ideas herein can be applied to selling any other fixed commodity. For instance, a percentage of all impressions on a particular website can be sold, or a market mechanism can be used to buy and sell portions of the traffic of a particular website. Similarly, an advertising supported program, such as email or instant messaging, could sell a percentage of all ads displayed in the program, or a percentage of ads shown for messages containing a certain word.

To the accomplishment of the foregoing and related ends, certain illustrative aspects are described herein in connection with the following description and the annexed drawings. These aspects are indicative, however, of but a few of the various ways in which the principles of the claimed subject may be employed and such subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high-level block diagram of an advertisement sales system.

FIG. 2 is a block diagram of a system for selling a percentage of impressions.

FIG. 3 is a block diagram of a system for selling a percentage of impressions at a determined price.

FIG. 4 is a block diagram of a system that displays impressions randomly upon receipt of a keyword.

FIG. 5 is a block diagram of an auctioning system that can be utilized to sell a percentage of impressions to a purchaser.

FIG. 6 is a representative flow diagram of a methodology for selling a percentage of impressions.

FIG. 7 is a representative flow diagram of a methodology for randomly displaying an advertisement.

FIG. 8 is a representative flow diagram of a methodology for maximizing revenue with respect to a percentage of impressions.

FIG. 9 is a high-level block diagram of a system that facilitates selling impressions or advertising space by way of a posted price market.

FIG. 10 is a block diagram of a system that facilitates determining price information associated with impressions that are sold by way of a posted price market.

FIG. 11 is a block diagram of a system that facilitates estimating demand in connection with determining price information associated with impressions that are sold by way of a posted price market.

FIG. 12 is a block diagram of a system that facilitates conversion of sale parameters.

FIG. 13 is a block diagram of a system that facilitates analyzing inventory in connection with selling impressions by way of a posted price market.

FIG. 14 is a block diagram of a system that facilitates analyzing proxies to estimate demand associated with impressions, the demand utilized to generate pricing information for impressions sold by way of a posted price market.

FIG. 15 is a representative flow diagram illustrating a methodology for selling impressions by way of a posted price market.

FIG. 16 is a representative flow diagram illustrating a methodology for determining demand associated with impressions.

FIG. 17 is a representative flow diagram illustrating a methodology for converting a purchase from a percentage-based purchase to a purchase based on disparate parameters.

FIG. 18 is a representative flow diagram illustrating a methodology for providing a futures, options, and/or derivatives market for impressions.

FIG. 19 is a representative flow diagram illustrating a methodology for modifying prices of impression based upon analysis of proxies.

FIG. 20 is a representative flow diagram illustrating a methodology for clustering search terms for pricing purposes.

FIG. 21 is a block diagram of a system that facilitates artificially altering supply of impressions.

FIG. 22 is a schematic block diagram illustrating a suitable operating environment.

FIG. 23 is a schematic block diagram of a sample-computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such subject matter may be practiced without these specific details. In other instances, well-known structures and devices are shown in block diagram form in order to facilitate describing the claimed subject matter.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, the claimed subject matter may be implemented as a method, apparatus, or article of manufacture using standard programming and/or engineering techniques to produce software, firmware, hardware, or any combination thereof to control a computer to implement the disclosed invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

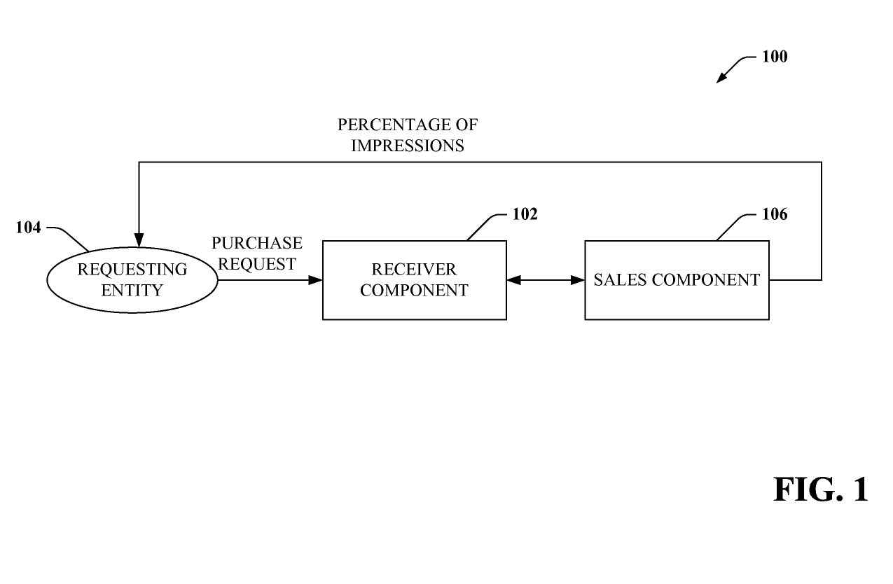

Referring now to the drawings, FIG. 1 illustrates a system 100 that can be utilized to sell impressions (advertising space) on a percentage of impressions basis. Fraud in connection with online advertising is becoming an enormous concern for companies, such as those that maintain search engines. For instance, click fraud can cost such companies (or advertisers that utilize search engines) a substantial amount of monies over time. The system 100 is designed to mitigate opportunities for click fraud and impression fraud with respect to online advertising. The system 100 additionally reduces a need to determine which impressions are falsely generated (through fraudulent entrance of keywords into a search engine, for instance), as fraudulently initiated impressions are spread across the percentage of impressions purchased.

The system 100 includes a receiver component 102 that receives a request to purchase a particular percentage of impressions with respect to one or more keywords from a requesting entity 104. In more detail, the requesting entity 104 can request to purchase advertising space with respect to one or more keywords provided to a search engine, application, and/or third party web page. Still further, advertising space can be sold based upon exact matches or broad matches. Exact matches occur when an advertiser has purchased advertising space with respect to a precise keyword or set of keywords. In a specific example, the requesting entity 104 can purchase a percentage of all impressions with respect to the exact keyword “digital.” If, however, a search user uses the keywords “digital camera,” an impression associated with the requesting entity 104 will not be provided (as “digital” and “digital camera” are not exact matches). In another example, broad matches can be purchased by the requesting entity 104. For instance, the requesting entity 104 can purchase a percentage of impressions associated with a particular prefix, a particular suffix, certain noun phrases, etc. Still further, percentage of impressions can be based at least in part upon geographic region, which can be included within a set of keywords, determined through a location sensor, or any other suitable manner for determining locations. Moreover, percentage of impressions can be purchases as a function of IP address, demographic information, and the like. Different manners for selling and purchasing percentages of impressions for certain keywords are described in more detail below.

The receiver component 102 can be communicatively coupled to a sales component 106, which can sell a percentage of impressions with respect to one or more keywords to the requesting entity 104. The price of sale can be determined through various price setting means, including through use of a posted price market, an auction, etc. Further, the requesting entity 104 can be billed for the purchase, can pay in advance, and the like. Once the sales component 106 has effectuated the purchase of a percentage of impressions for one or more keywords, use of such keywords in a search engine may result in display of an impression associated with the requesting entity 104. For example, if the requesting entity 104 purchased ten percent of impressions associated with the keyword “camera” (exact match), then approximately one of every ten impressions for such keyword will be that of the requesting entity 104. Therefore, even if a competitor to the advertiser generates false searches with the keyword, the advertiser will not be negatively affected (unless the competitor discerns a pattern in impressions). It is therefore important to display impressions randomly while still displaying advertisements at a purchased percentage.

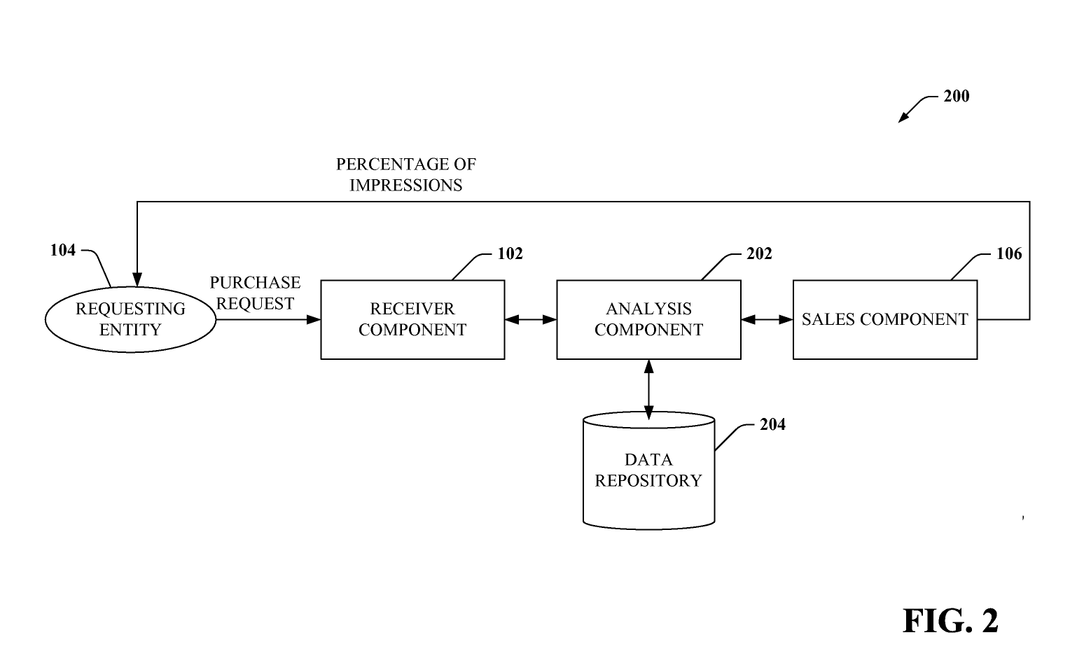

Turning now to FIG. 2, a pay-per-impression sales system 200 is illustrated. The system 200 includes the receiver component 102 that receives a request to purchase a particular percentage of impressions associated with one or more keywords from the requesting entity 104. As stated above, the requesting entity 104 may wish to purchase a percentage of impressions based upon an exact keyword match, a broad match, or any other suitable match. The receiver component 102 is communicatively coupled to an analysis component 202, which is employed to ensure that impressions are not “over sold.” In other words, the analysis component 202 ensures that the sales component 106 sells one hundred percent or less of impressions for particular keywords. To undertake this task, the analysis component 202 can analyze contents of a data repository 204, wherein the data repository 204 can be utilized to retain sale of advertisements with respect to various keywords.

As stated above, it may be desirable to sell percentages of impressions based upon both broad and exact matches. As a precursor to describing the system 200 combining broad and exact matches, the system 200 can be considered with respect to broad matches alone (which is more complex than exact match pay-per-percentage). For instance, two advertisers may exist, wherein a first advertiser has purchased eighty percent of traffic for the keyword “digital” and a second advertiser has purchased eighty percent of the traffic for “camera.” If, however, 100% of all searches containing “digital” or “camera” are for “digital camera”, there is no suitable manner for meeting these constraints. The problem can be avoided through the analysis component 202 using estimates of relative traffic of various words and phrases. For example, if it is known that there are typically one hundred searches for “digital camera” and four hundred searches for “camera”, the analysis component 202 can allow sale of 100% of matches for broad match “digital” to one advertiser and 80% of matches for broad-match “camera” to another. Even if the estimates are correct, however, the system 200 may remain susceptible to fraud.

Accordingly, the system 200 can employ an algorithm for selecting a match between search phrases and keywords that is independent of possible actions of a party desiring to commit fraud. For example, an alphabetical method can be employed, wherein a first word in a message is chosen in alphabetical order and broad matches are chosen for that word. In another example, a most valuable word can be selected, wherein values are published before bid-time and values are estimated according to a heuristic carefully chosen to be difficult to influence. In still another example, a word can be chosen at random. More specifically, a word within a phrase is chosen at random as a target, and then such word is selected based upon a percentage of volume purchased. For instance, if an advertiser purchases a weighted 10% share of the broad matches for the word “camera”, he can receive the following: 10% of exact match searches for “camera”, 5% of searches for two word phrases that include “camera”, 3.33% of searches for three word phrases that include camera, etc. When selling such advertisements (impressions), in order to aid in preventing fraud, the analysis component 202 still can respect certain constraints. For instance, if the sales component 106 sells 70% of matches for “camera” and 80% of matches for “digital”, then for a phrase such as “digital camera” the sales component 106 can sell no more than 25% of the traffic (100%−(70%/2+80%/2)=25%). Enabling sale for broad matches in this manner is immune to fraud, as all independence assumptions are observed. For a given real advertisement, the chance that any particular advertiser is chosen depends only percentages purchased, and is otherwise independent of actions of other advertisers.

In another method, a first or last word can be chosen with respect to selling percentages of impressions. In such a case, rather than selling a full broad match, the sales component 106 can sell prefixes or suffixes. For instance “digital *” would match “digital camera” and “digital computer” but not “secure digital”. An arbitrary percentage can thus be easily sold and there is certainty that the system 200 has not over sold a key word or phrase. Prefixes and suffixes can be sold by the sales component 106 in an auction manner or any other suitable manner. Moreover, the sales component 106 and the analysis component 202 can operate in conjunction to enable sale of advertisements through pay-per-percentage of impressions, pay per impressions, pay-per click, and the like in combination. For instance, some advertisers may simply prefer traditional advertising types. The system 200 enables traditional advertising methods to be combined with a pay-per-percentage advertising method.

For instance, if the sales component 106 sells advertisements with respect to keyword(s) in an auction, advertisers can bid either for a percentage of all advertising, on a pay-per-click basis, and/or on a pay-per impression basis. Some traffic can thus be allocated to pay-per percentage, some to pay-per impression, and some to pay-per click. The goal of the system 200 can be to maximize revenue. To be clear, a pay-per-percentage advertiser can purchase x % of impressions (that is x % of all impressions). If less than 100% of impressions are allocated to pay-per-percentage bidders y % of the time, then at random y % of the time a pay-per percentage advertisement can be displayed while 100-y % of the time a pay-per-click or pay-per-impression advertisement can be displayed. The analysis component 202 can undertake selecting which percentage (y) to allocate to pay-per click advertisements to maximize revenue. An example of such analysis is provided in more detail below with respect to an auctioning system.

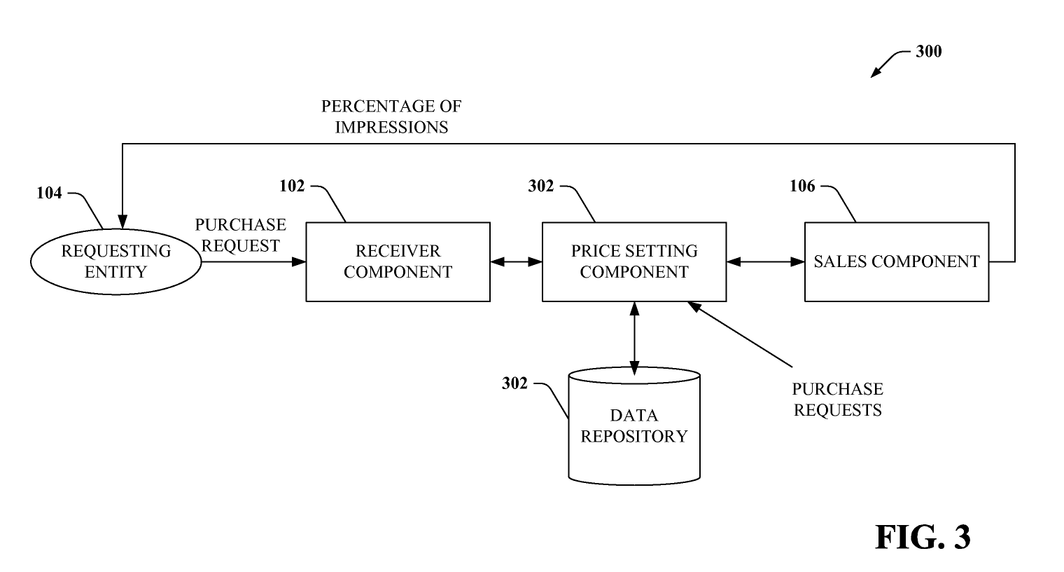

Referring now to FIG. 3, a system 300 for selling online advertisements with respect to a pay-per-percentage sales model is illustrated. Thus, if an advertiser purchases 10% of advertisements with respect to a particular keyword, roughly one of ten searches using the keyword will result in display of the advertiser's advertisement. Display of advertisements is described below. The system 300 includes the receiver component 102 that receives a request to purchase a percentage of impressions with respect to a particular keyword or phrase that is provided to a search engine or other suitable application. The receiver component 102 is communicatively coupled to a price setting component 302, which can receive a plurality of purchase requests from various advertisers with respect to a myriad of keywords. Thus, the price setting component 302 can utilize an auction in connection with setting prices for certain keywords. In another example, a value can be estimated for certain keywords or phrases through analyzing past auctions or fees paid with respect to same or similar keywords. For instance, the price setting component 302 can analyze previous prices with respect to keywords that are retained within a data repository 304. Based upon such analysis, the price setting component 302 can infer a price to set with respect to keywords and/or phrases.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention. Thus, in a particular example, the price setting component 302 can review keywords and previous advertising fees associated with the keywords and make a probabilistic determination regarding a price associated with certain keywords. Additionally, the price setting component 302 can set a minimum price with respect to particular keywords of low demand (e.g., the keywords or phrases are not typically used for searching). The price setting component 302 can select a pricing mechanism that maximizes revenue for a seller of advertising space.

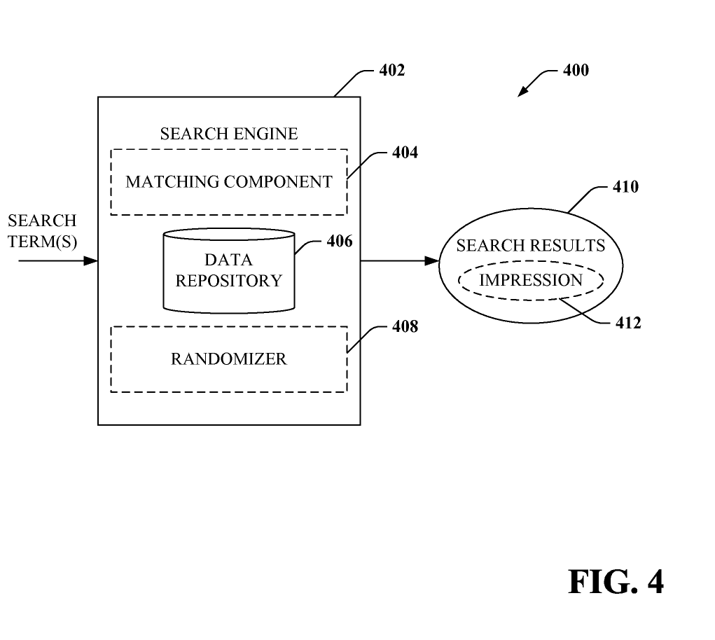

Now referring to FIG. 4, a system 400 that selectively displays advertisements to a user is illustrated. The system 400 includes a search engine 402 that receives one or more search terms (e.g., queries). The search terms can be received from a user, from a web page, a URL, etc. The search terms can be provided to a matching component 404 within the search engine, which determines whether advertisements are desirably displayed with respect to the search terms. For instance, the matching component 404 can parse the received search terms and determine whether an advertiser has purchased advertisements with respect to at least one keyword within the search terms. The matching component 404 can be configured to perform matching based upon how advertisements are sold (e.g., exact matches, broad matches, and/or a combination thereof). In more detail, the matching component 404 can access a data repository 406 within the search engine 402, wherein the data repository 406 includes information relating to advertisers who have purchased percentages of impressions with respect to particular keywords. Each keyword may be associated with several advertisers, as different advertisers can be associated with a different percentage of impressions. In other words, the matching component 404 can determine a pool of possible advertisements to display as well as a percentage associated therewith.

Once the matching component 404 has analyzed contents of the data repository 406 to determine advertisements associated with the search terms and percentages associated therewith, a randomizer 408 can be employed in connection with determining which advertisement to display. It might seem that the best way to show advertisements in a pay-per-percentage system is in rotation (e.g., if an advertiser has 50% of ads associated with the received search terms, an advertisement associated with the advertiser should be displayed upon every other occurrence of receipt of the search terms). This minimizes a variance in a percentage actually received by advertisers. In order, however, to keep a pay-per-percentage system resistant to fraud, it is important that advertisements be shown at random. Otherwise, an attacker may be able to engage in some form of impression fraud. For instance, if an attacker determines a display pattern, they can effectively commit impression fraud with respect to an advertiser. Use of the randomizer 408 (wherein advertisements are weighted according to percentages associated therewith) mitigates this possibility of fraud.

The randomizer 408 can employ the following procedure in conjunction with the matching component 404 to effectuate random display of advertisements. For instance, an advertiser i can purchase xᵢ% of a keyword, wherein advertisements are exact match. At each receipt of a purchased keyword (or keywords), with probability xᵢ/100, advertiser i's advertisement can be shown. As the probabilities are, by assumption, independent, no adversary can change the expectation of a number of times that advertiser i's advertisement will be shown.

The randomizer 408 can also be employed to display advertisements in a random order. For example, one hundred advertisers may each purchase one percent of impressions with respect to a particular keyword. Advertisements associated with the advertisers can be displayed in a random order when search terms are received by the search engine 402. When each advertisement has been displayed, a new random order can be generated by the randomizer 408. Such use of the randomizer 408, however, remains susceptible to some fraud, as process of elimination can be utilized to determine when certain advertisements will be displayed for particular search terms. In another example, advertisements can be displayed in an order that is based upon an estimate of expected total traffic over a time period, and thereafter utilizing a shuffling method over total expected traffic.

Once the matching component 404 has located several advertisements and the randomizer 408 has been employed in connection with selecting a particular advertisement, the search engine 402 can output search results 410 that includes the selected advertisement 412 (impression). Randomly displaying advertisements using a pay-per-impression approach is associated with several benefits over conventional advertising schemes, including the fact that it is easier to determine a percentage of real impressions when compared to determining which impressions are real. Moreover, there are fewer data sparsity issues in determining the real volume for a keyword when compared with determining a volume for a keyword for a specific advertiser. Additionally, pay-per-percentage places control in the hands of the advertiser—they can choose from multiple sources. Further, an advertiser who has found a profitable keyword need not worry that someone can use fraud to disrupt profit.

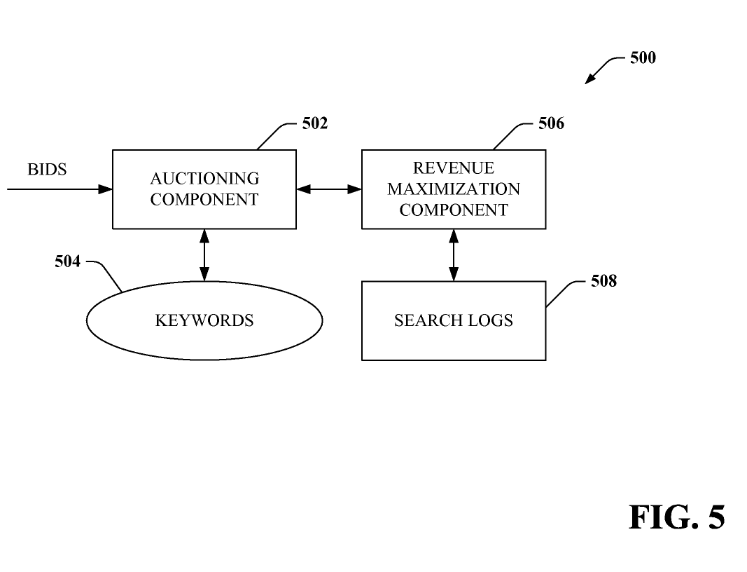

Now turning to FIG. 5, a system 500 that can be utilized in connection with auctioning advertising space associated with one or more keywords is illustrated. The system 500 includes an auctioning component 502 that receives bids for one or more of broad matches and exact matches for keywords 504. To enable sale of both broad and exact matches, the auctioning component 502 can rewrite search terms so they all appear as, for instance, prefix matches (although a similar rewriting can be undertaken to enable suffix matches). For instance, each search for “x y z” can be rewritten as “x y z<END>”, such that an exact match keyphrase “x y z” can be viewed as being a prefix match for “x y z<END>*”. For simplicity, the system 500 is discussed as a first price auction, although variations on the techniques described here can be used to create second-price (Vickrey) auctions. An advantage of first-price auctions is that a competitor to an advertiser cannot affect the price the advertiser pays for a keyword, except by actually purchasing it. This minimizes the impact competitors have on prices of advertisements.

The auctioning component 502 can consider bids of the following type: an advertiser bids for a % of a keyword, and is willing to pay price p per percent, up to p×a total. The advertiser may provide the auctioning component 502 with several bids. By way of example, the advertiser may be willing to pay three cents per percentage for a first ten percent, two cents per percentage for the second ten percent, and one cent per percentage for the third ten percent. Moreover, the auctioning component 502 can operate in conjunction with a revenue maximization component 506 to combine bids in order to maximize revenue. In particular, the auctioning component 502 and the revenue maximization component 506 can combine bids for x* with bids for xy* such that the bids are competing in order to increase revenue for the auctioning system 500. Similarly, bids for xy* can be combined with bids for xyz* prior to combining such bids with x*. Thus, a hierarchical combination of bids can be undertaken by the revenue maximization component 506.

Pursuant to an example, the auctioning component 502 can begin receiving bids for a long keyphrase, such as xyz*. These bids can then be combined with bids for xy*, wherein top bidders for each category are retained. Such bids can then be combined with bids for x*, thereby increasing bidding price and revenue for the system 500. An example follows to illustrate such maximization of revenue. The auctioning component 502 can receive bids as follows: $1.00 for 80% of advertisements associated with the keyphrase “digital *”, $0.75 for 60% of advertisements associated with the keyphrase “digital equipment *”, and $0.75 for 70% of advertisements associated with the keyphrase “digital camera *”. The revenue maximization component 506 can cause bids for “digital camera *” and “digital equipment *” to be combined into a special “digital ?*” bid that competes with the “digital *” bid. This results in the following set of bids: $1.00 for 80% of advertisements associated with the keyphrase “digital *”, $1.50 for 60% of advertisements associated with the keyphrase “digital ?*”, and $0.75 for 10% of advertisements associated with the keyphrase “digital ?*”. The auctioning component 502 can now run bidding to assign 60% of the traffic to “digital ?” and 40% to “digital *”. Once the 60% has been assigned to “digital ?*”, the auctioning component 502 can assign traffic for that to the “digital equipment *” and “digital camera *” bidders (who don't compete with one another).

In practice, the following algorithm can be utilized (which maps to the previous example, but aggregates bids in 1% quantiles for simplicity).

let virtual [x, 1... 100] = 0;
for each bid for a% of xy* at a price p, in descending order by price

let b = min (a, 100-bids[xy*]) (bidding not to exceed 100%)
for I = bids [xy*] to bids [xy*] + b − 1

virtual [x, i] +=p;

bids [xy*] += b

The revenue maximization component 506 in this example has created a set of virtual bids for x?* that represent a value obtained if part of the x* traffic is allocated to bids of the form xy*. The auctioning component 502 can run an auction using real x* bids plus the virtual bids, each of which is a bid for 1% (for example) of the x* traffic at price virtual [x, i]. Once traffic has been allocated to the virtual bids, the auctioning component 502 can sum the traffic assigned to xy* bids and can run a sub-auction for each xy* bid up to a total amount allocated to x?*. In other words, for each x*, for each percentage, the revenue maximization component 506 determines how much money could be made if that percentage was allocated to bids of the form x?*, and then allow those x?* bids to compete against actual bids. That this maximizes potential revenue can be shown with the following algorithm, given a prefix x and a percentage of revenue j,

$${\sum }_{i = 1}^{j} virtual [ x , i ] .$$

Such algorithm represents revenue that can be obtained from assigningj % of traffic to xy bids. The revenue maximization component 506 can assign traffic to x?* bids to the extent that it exceeds the traffic obtainable from x* bids. The undertaken auction can cover any suitable amount of time, including an hour, a day, a week, a month, etc.

Additionally, it is to be understood that the auctioning component 502 can receive bids that are confined to a particular location, to individuals of certain age range, gender, etc. Various constraints can be applied to ensure that percentages of advertisements are not oversold. Furthermore, the revenue maximization component 506 can employ estimates of value with respect to the keywords 504 in connection with maximizing revenue. In particular, the revenue maximization component 506 can analyze search logs 508 for frequency of searching with respect to particular terms. The revenue maximization component 505 can additionally estimate which searches within the search logs 508 are fraudulent and which ones are real.

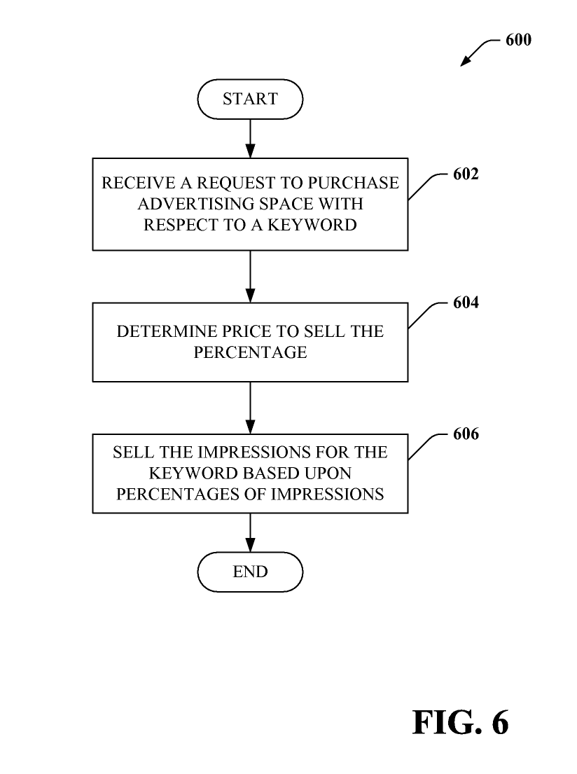

Referring now to FIGS. 6-8, methodologies in accordance with the claimed subject matter will now be described by way of a series of acts. It is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning solely to FIG. 6, a methodology 600 for selling advertising space with relation to one or more keywords is illustrated. At 602, a request to purchase advertising space with respect to at least on keyword is received. For example, the request can be for an exact match, a suffix, a prefix, noun phrases, and the like. Furthermore, the request can be associated with location constraints, position constraints (e.g., where on a page that impressions are to be displayed), and the like. For instance, different positions may have different click-through rates, and thus the request to purchase advertising space can be associated with a particular position. In another example, different positions can be assigned different values, and the request to purchase advertising space can be based at least in part upon aggregate values with respect to the positions.

At 604, a price that a percentage of impressions can be purchased is determined. For instance, the price can be determined through an auction, where the amount maximizes revenue for a search engine. In another example, demand associated with the keyword can be estimated, and the price can be set as a function of the determined demand. It is thus understood that any suitable manner for determining price is contemplated by the inventor and intended to fall under the scope of the hereto-appended claims. At 606, advertising space is sold based upon a percentage of impressions. Selling through a percentage of impressions mitigates opportunities for click fraud, impression fraud, etc.

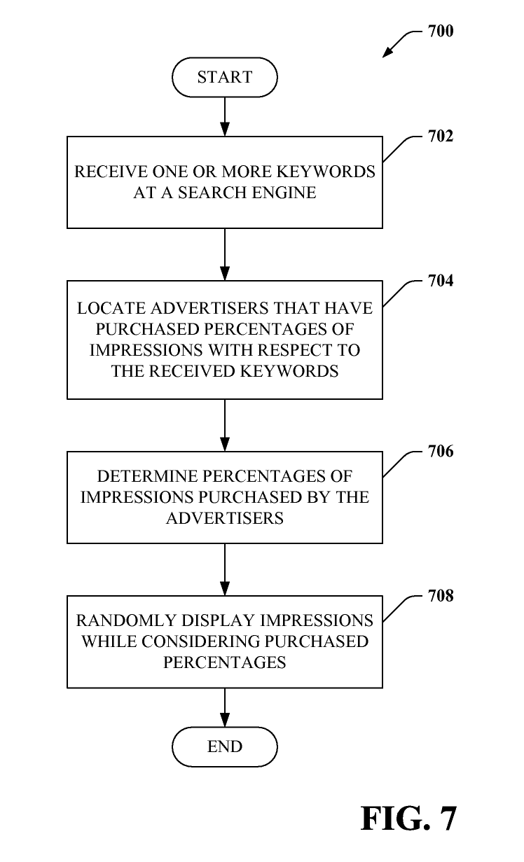

Now referring to FIG. 7, a methodology 700 for displaying advertisements relating to keywords is illustrated. At 702, one or more keywords are received at a search engine. By way of example, individuals often search for information on the Internet by providing search terms to a search engine. Search engines earn revenue by selling advertisements to businesses or individuals with respect to particular keywords. For instance, an electronics company may wish that an advertisement be displayed if the term “digital” is provided to the search engine. In conventional advertisement sales systems, an advertiser would purchase a particular number of advertisements and would be charged upon display of the advertisements or upon a user clicking the advertisements. As described above, this enables fraud to be undertaken against an advertiser. Selling advertisements as percentages of impressions with respect to certain keywords, however, can mitigate opportunities for fraud.

At 704, one or more advertisers that have purchased percentages of impressions with respect to the received keywords can be located. For example, several advertisers may have purchased percentages of impressions with respect to the received keywords (up to 100%). At 706, percentages of impressions purchased by each of the advertisers can be determined. For example, three advertisers may have purchased percentages of impressions with respect to the received keywords, wherein the first advertiser purchased 25%, the second advertiser purchased 35%, and the third advertiser purchased 40%. At 708, impressions are randomly displayed while considering an amount of percentages purchased by the advertisers. Continuing with the above example, there is a 25% probability that an advertisement associated with the first advertiser will be displayed, a 35% probability that an advertisement associated with the second advertiser will be displayed, and a 40% probability that an advertisement associated with the third advertiser will be displayed. The selection of the advertisement, however, occurs at random, thereby prohibiting a fraudster from discerning a pattern and defrauding any of the advertisers.

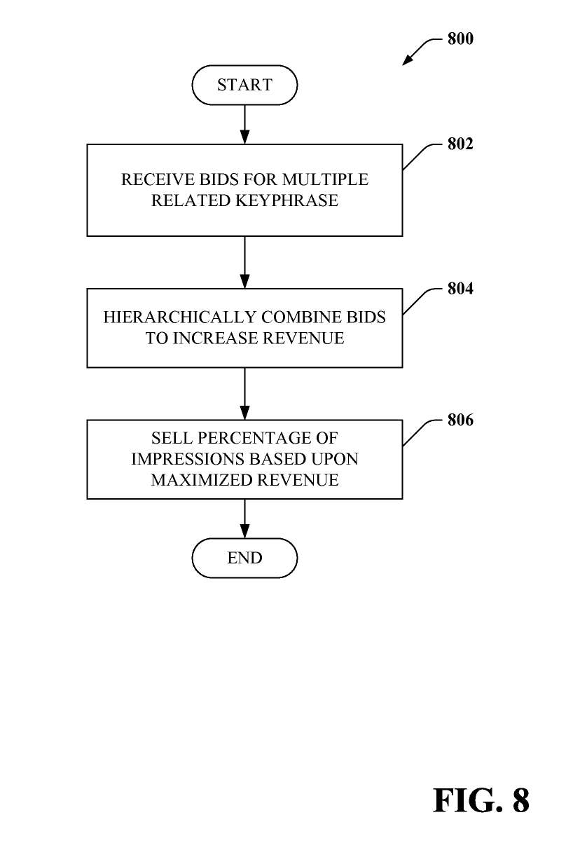

Now turning to FIG. 8, a methodology 800 for selling a percentage of impressions while maximizing revenue is illustrated. At 802, bids are received for multiple related keyphrases. For instance, bids can be received for a keyword x, a set of keywords xy, a set of keywords xz, a set of keywords xyq, etc. Additionally, the bids can be for particular positions with respect to search results, as different positions may be associated with different click-through rates. One way to handle such situation is to assign different values to different positions (e.g., based upon average click-through rates). Advertisers can then bid for a percentage of the total of the relative value. That is, with four positions, the first position might be worth 4 points, the second worth 3 points, the third worth 2 points, and the forth worth 1 point. If twelve advertisements are shown (120 points total), and an advertiser has purchased 10% of all points, the ad might be shown 12 times in the fourth position, or 6 times in the third position, or 3 times in the second position, or some combination. Thus, received bids can for purchasing a percentage of all points for a given keyword rather than a percentage of all impressions for the keyword.

At 804, bids are hierarchically combined to increase revenue. For instance, bids for the terms xy* and xz* can be combined and utilized to competed with bids for x*. Such combination has been described in detail above. At 806, percentages of impressions (or points) can be sold based upon maximum revenue. For example, percentages can be sold while retaining certain constraints (not overselling, constraining based upon location, etc.).

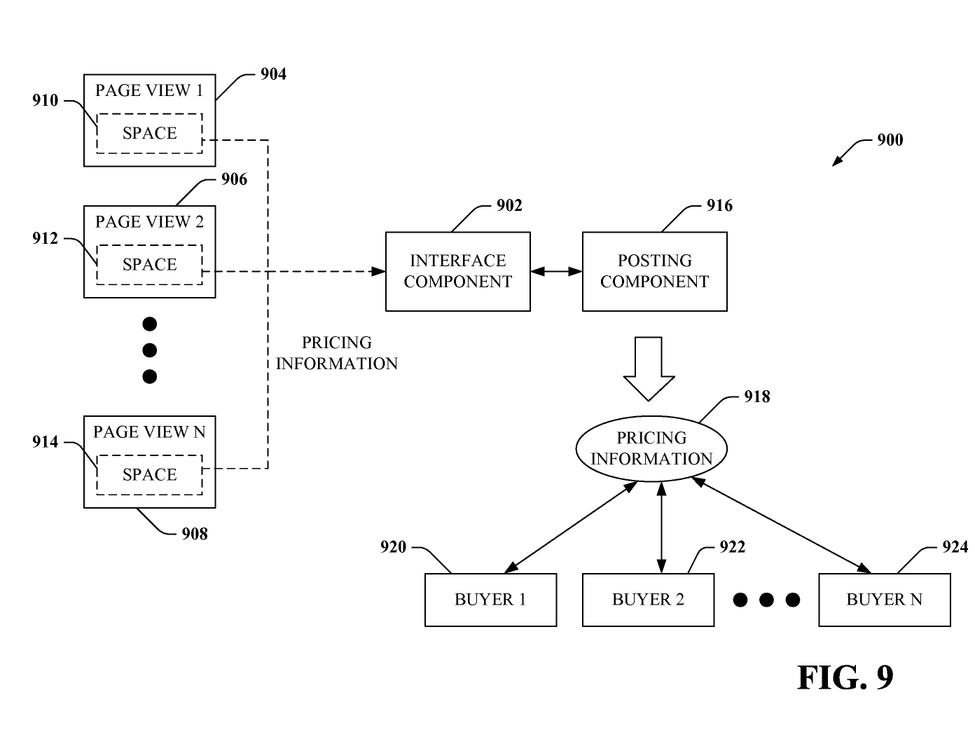

Referring now to FIG. 9, a system 900 that facilitates sale of advertising spaces associated with page views by way of a posted-price market is illustrated. Conventional systems/methods for selling advertising spaces utilize an auction to sell such spaces, wherein bids are received and analyzed at a time that a web page is loaded. While in some instances sale by auction is desirable, posted-price markets are associated with various benefits over auctions. For instance, market mechanisms often are associated with higher customer satisfaction when compared to auctions, as markets provide buyers with a greater amount of control over purchases when compared to auctions. For instance, buyers can simply review available inventory and prices associated therewith and specify a number of items to purchase, being certain that they can obtain the desired number of items at the specified price. Further, utilization of a market mechanism provides an opportunity to create a futures market, an options market, a derivatives market, and the like, thereby decreasing variance of revenue of a seller and expenditures of a buyer (e.g., leading to more stable revenue and expenditure streams).

The system 900 includes an interface component 902 that receives pricing information relating to a plurality of page views 904-908. In more detail, each of the page views 904-908 is associated with at least one space that can be purchased for advertising purposes. For example, the first page view 904 is associated with at least one space 910, a second page view is associated with at least one space 912, and an Nth page view 908 is associated with at least one space 914. Further, the page views 904-908 can relate to a page returned from a search engine based upon one or more particular search terms, a web page returned from entering a Uniform Resource Locator into a web browser, selection of a link, and the like. The spaces 910-914 that can be purchased can be associated with a location upon the page views 904-908, a size, a timeframe that an advertisement can be displayed upon the page views 904-908, etc. Thus, a space can be defined by way of any number of suitable parameters. To further clarify, the page view 904 may be associated with a search term that is frequently utilized, and the space 910 associated therewith can be of substantial size and in a location that would be desirable to an advertiser. Thus, there may be a high demand (and thus a high price) associated with the space 910. As discussed in more detail below, demand can be estimated and utilized to aid in determining a price for which to sell the space 910.

In one example, the pricing information received by the interface component 902 can relate to a percentage of times that a space will feature a buyer's advertisement. For example, the page view 906 can be associated with a particular search term; therefore, for each instance that the term is entered into a search engine, the page view 906 can be provided to a user. Thus, if the term is entered ten times, then the page view 906 can be generated ten times (and the space 912 can be utilized for advertising ten times). The pricing information provided to the interface component 902 can relate to a percentage of the page views in which an advertisement associated with a buyer will appear. Accordingly, the pricing information can be for ten percent of page views associated with a search term. Therefore, one out of ten times the search term is employed by a search engine, the space 912 will be occupied by an advertisement of a buyer. The percentages can vary per search term and/or content page and can be defined based at least in part upon demand, as it would be beneficial to a buyer to allocate percentages to maximize revenue.

The interface component 902 is communicatively coupled to a posting component 916 that posts pricing information 918 so that it is accessible to a plurality of buyers 920-924. Each of the buyers 920-924 can thus have knowledge of a price associated with each space 910-914 on each page view 904-908, and can purchase a percentage of impressions that will appear in such space 910-914 (where an impression is an advertisement's appearance on a page view). As the posted price market can operate in a manner similar to financial markets, it can be discerned that the purchased percentages of impressions can be bought and sold based upon futures contracts on a futures market. Similarly, the percentages of impressions can be bought and sold based upon options contracts, derivatives contracts, and the like.

To more fully explain various aspects of the claimed subject matter, a specific example is provided herein. It is understood, however, that the example is intended to be explanatory and not limitative in any manner. The first buyer 920 may be a flower company interested in advertising to users of a search engine who are utilizing the term “rose” as a search term. The first page view 904 is associated with searches utilizing such search term, and includes a space 910 that can be purchased for advertising purposes. Pricing information 918 can be posted which indicates a price for a percentage of impressions that the first buyer 920 can purchase. In a particular example, the pricing information 918 can state that the first buyer 920 can purchase the space 910 for ten percent of occurrences of the first page view 904 at a defined price. The first buyer 920 has access to the pricing information 918, as it is posted by the posting component 916. The first buyer 920 can thereafter make a determination regarding whether they wish to undertake such purchase. With further specificity regarding the pricing information 918, such pricing information 918 can define a timeframe that the spaces 910-914 are available, a time in the future that the spaces 910-914 are available, etc. For example, the pricing information 918 can inform the first buyer 920 that a space is available at a particular point in time in the future. Similarly, the pricing information 918 can include option information. Thus, the pricing information 918 can include data that aids the buyers 920-924 in making informed decisions regarding purchases of advertising space.

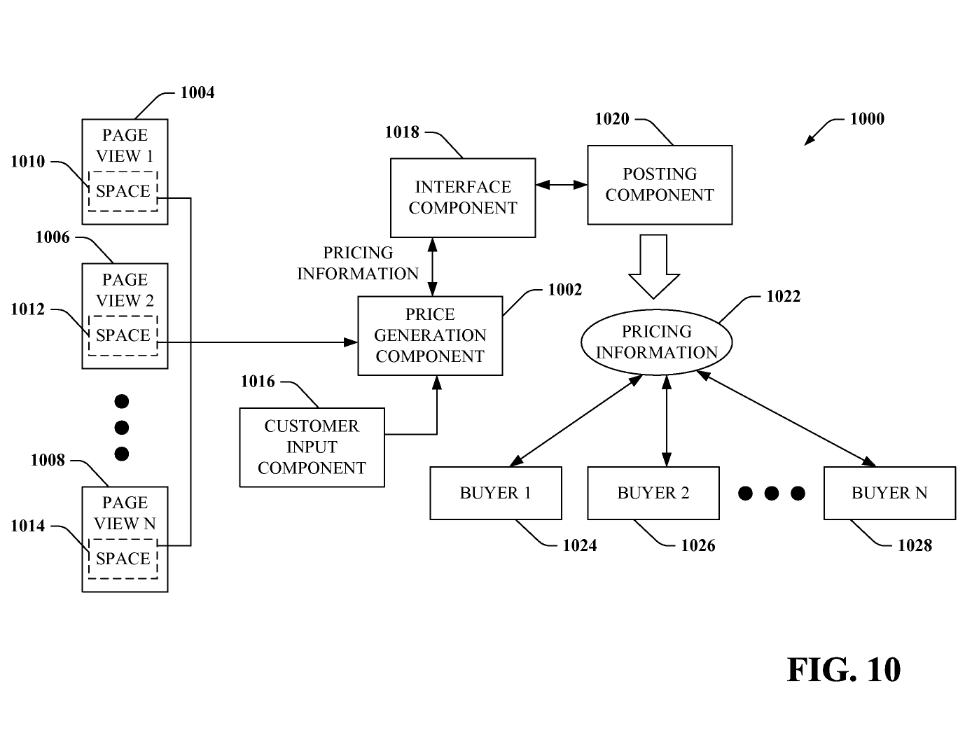

Turning now to FIG. 10, a system 1000 that facilitates sale of advertising space with respect to a plurality of page views by way of a posted price market is illustrated. The system 1000 includes a price generation component 1002 that generates pricing information with respect to a plurality of spaces resident upon a plurality of page views. The spaces can be associated with a particular position on a page view, a specified size, a particular time and/or timeframe, etc. For convenience of terminology, spaces upon a page view can be referred to as partial page views. The price generation component 1002 specifically can generate pricing information with respect to page views 1004-1008 and spaces 1010-1014 (or partial page views) associated therewith. For example, the price generation component 1002 can analyze supply of the spaces 1010-1014 associated with the page views 1004-1008 in connection with determining prices associated with such spaces 1010-1014. For instance, as the spaces 1010-1014 can be sold in a market forum, such spaces 1010-1014 (or percentages associated with traffic relating to the page views 1004-1008) can be sold as future commodities. The sale of the spaces 1010-1014 or percentages associated therewith can be tracked to effectively determine supply, and the price generation component 1002 can generate pricing information based at least in part upon the supply.

The price generation component 1002 can also be associated with a customer input component 1016 that enables customers to provide input relating to demand of purchasers or prospective purchasers of the spaces 1010-1014. For example, a prospective purchaser can indicate that they would be interested in purchasing the space 1010 associated with the first page view 1004 (which can correspond to a search term entered into a search engine). Data can be voluntarily provided by purchasers or prospective purchases to the customer input component 1016 relating to demand associated with one or more spaces—accordingly, data obtained therefrom can be considered in light of possibility of fraud to affect demand (and thus price) in a manner beneficial to a purchaser or prospective purchaser of one or more spaces.

The pricing information generated by the price generation component 1002 can be provided to an interface component 1018 that is communicatively coupled to a posting component 1020. The posting component 1020 can post pricing information 1022 associated with the page views 1004-1008 generally and the spaces 1010-1014 associated therewith specifically to a plurality of prospective buyers 1024-1028. As described above, the pricing information 1022 can relate to a percentage that the buyers 1024-1028 can purchase, wherein the percentage is associated with a percentage of times that an advertisement will be displayed upon a given page view. Thus, one of the buyers 1024-1028 can purchase the space 1012 for twenty percent of occurrences of the page view 1006. For example, if the page view 1006 relates to a content page, each time the page is loaded within a specified time range the space 1012 will display advertising content relating to one of the buyers 1024-1028. If the buyer 1024 purchases the space 1012 for twenty percent of occurrences of the page view 1006, then an advertisement associated with the buyer 1024 will be displayed in the space 1012 twenty percent of the time that the page view 1006 is loaded. As the spaces 1010-1014 (in terms of percentages, for example) can be sold on a posted-price market, creation of a futures market, an options market, a derivatives market, and other suitable markets can be created.

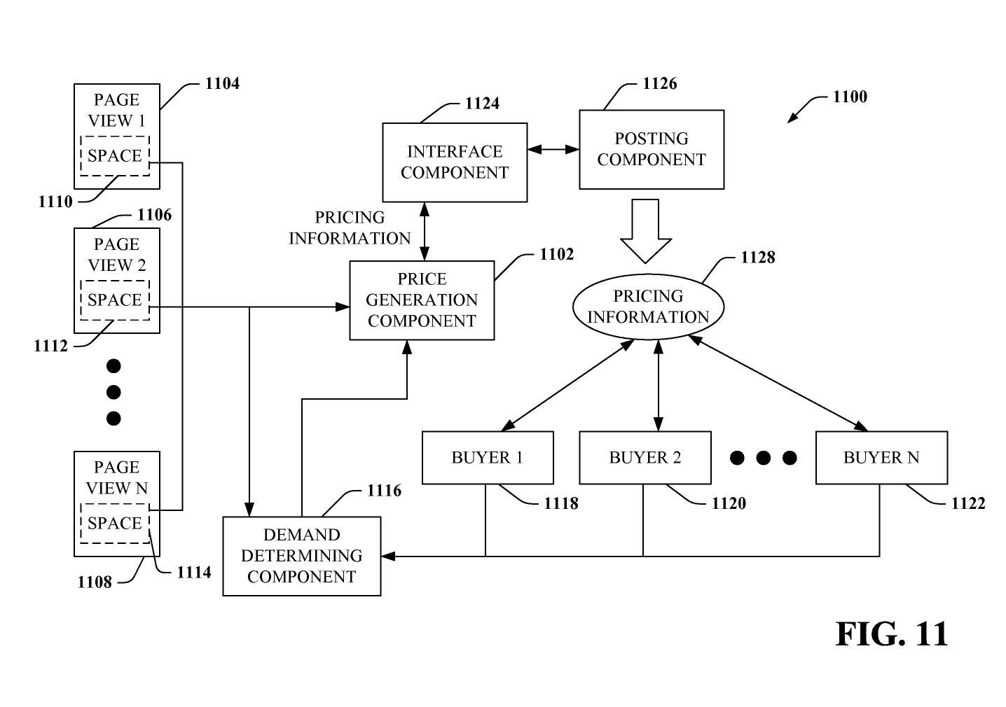

Now referring to FIG. 11, a system 1100 that facilitates sale of advertising space upon page views is illustrated. The system 1100 includes a price generation component 1102 that is employed to generate prices with respect to search pages and/or content pages. For instance, advertisers may wish to advertise on particular web pages and/or with respect to specific search terms (wherein utilization of the terms in a search engine results in search pages). The price generation component 1102 can be utilized to generate pricing information with respect to portions of such search pages and/or content pages, thereby enabling prospective buyers to purchase the portions. In more detail, page views 1104-1108 are generated each time a search is undertaken utilizing a particular search term or terms and/or each time a URL is entered into a web browser (e.g., through typing, traversal of links, . . . ). Advertisers often wish to advertise on spaces 1110-1114 associated with the page views, particularly in instances that a web page that includes a space is associated with a product sold by a company wishing to advertise on such space. For instance, sporting goods retailers often wish to advertise on web pages relating to sports news as well as search pages where particular terms, such as “golf clubs”, are entered.

A demand determining component can be communicatively coupled to the price generation component 1102 and aid in determining a price for each of the spaces 1110-1114 at particular times. For example, it may be more desirable to advertise near lunch hour when compared to early morning, and the demand determining component 1116 can be utilized to determine/estimate such demand at the disparate times. For instance, the demand determining component 1116 can monitor the page views 1104-1108 over several time intervals and track unsold spaces associated therewith, thus indicating a lower demand for such spaces. Further, the demand determining component 1116 can monitor purchasing habits of a plurality of buyers 1118-1122 to aid in determining demand of each of the spaces 1110-1114 at specified time intervals. In one example, a data repository (not shown) can be utilized to store and organize inventory and purchasing data, and the demand determining component 1116 can analyze such data to assist in a determination of demand. It is thus understood that the demand determining component 1116 can employ any suitable mechanisms/methodologies for determining and/or estimating demand associated with the page views 1104-1108 and spaces 1110-1114 associated therewith.

Upon the pricing generation component 1102 creating pricing information associated with the page views 1104-1108 and related spaces 1110-1114, such pricing information can be relayed to an interface component 1124 that can then relay such pricing information to a posting component 1126. The posting component 1126 can posting pricing information 1128 in a posted-price market to the buyers 1118-1122, thereby enabling purchase of the spaces 1110-1114, percentages associated with the spaces 1110-1114, a particular number of clicks undertaken on the spaces 1110-1114, a particular number of secure clicks undertaken on the spaces 1110-1114, or any other suitable manner of selling advertising space upon a web page.

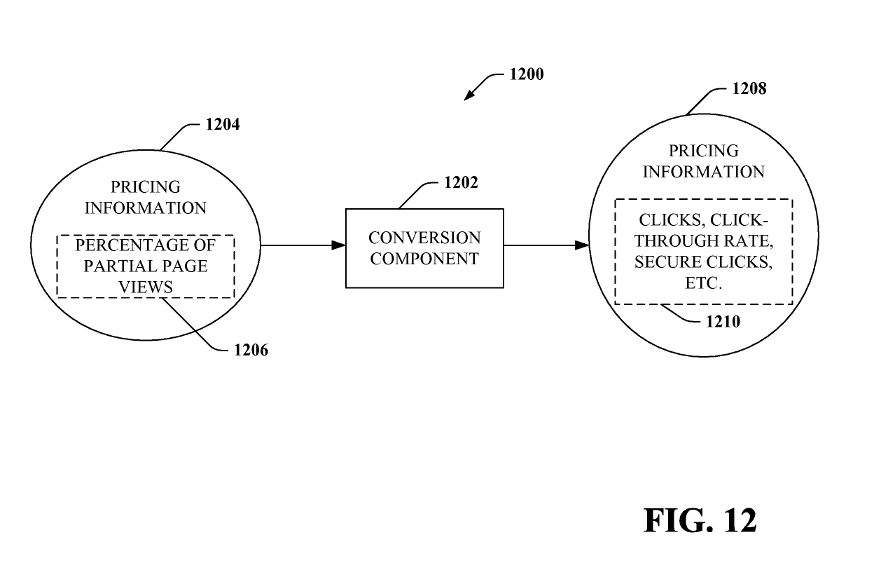

Now referring to FIG. 12, a system 1200 that facilitates conversion of a sale of advertising space associated with one parameter to payment for the sale by way of a different parameter. The system 1200 includes a conversion component 1202 that receives pricing information 1204 associated with a partial page view. As described above, a partial page view is a portion of a page view at a particular location, with defined size, and displayed during a specified time interval. In more detail, the pricing information 1204 reflects a price for a percentage of partial page views 1206. For instance, the pricing information 1204 can include a price to be paid by an advertiser for having an advertisement associated therewith displayed on ten percent of page views relating to a content page and/or a search page resultant from specified terms. In some instances, it may be desirable to not convert such pricing information 1204 to information based upon other parameters, such as clicks, as click fraud is becoming problematic and it is becoming increasingly difficult to receive payment based thereon. Pricing by way of the percentage of partial page views 1206 mitigates occurrences of click fraud so long as advertisements are displayed at random.

Some advertisers, however, may be wary of purchasing advertising space based upon percentages, as there is no guarantee that anyone will actually visit a web page or utilize particular search terms. More specifically, an advertiser may be concerned that they will pay for a percentage of a search term and that such term is not utilized—thus, they have effectively purchased a percentage of zero. Accordingly, to alleviate such concerns, the conversion component 1202 can convert the percentage into clicks, click-through rate, secure clicks, acquisitions undertaken by buyers, etc. For example, a purchaser can purchase advertising space by way of percentages, and thereafter have payments based upon clicks, a click-through rate, and the like. The conversion can be specific to an individual or company wishing to utilize space upon a content page or search page to advertise. For instance, a web page can relate to flowers, and a company selling flowers may wish to advertise thereon. The company can purchase space in terms of percentages of page views that will showcase the advertisement, and thereafter request that payment be based upon clicks. Depending at least in part upon an expected number of clicks that the advertisement will receive, a price per click can be generated by the conversion component 1202, and such price per click will be associated with a particular value. If the advertiser is selling sporting goods, however, the price per click will most probably be higher, as fewer clicks can be expected to occur for sporting goods upon a web page relating to flowers. In other words, the conversion component 1202 can convert pricing information from a first format to a disparate format in a manner that does not negatively impact a seller's expected revenue.

While not shown, it is understood that conversion tables can be associated with particular spaces as well as specific purchasers to effectuate conversion of the pricing information. Moreover, the conversion component 1202 can convert from percentage-based pricing information to a combination of disparate pricing parameters. For instance, converted pricing information 1208 can be a combination of clicks, click-through rate, secure clicks, acquisitions, etc. (e.g., the advertiser may wish to pay a first amount per click, a second amount per secure click, . . . ). The conversion component 1202 facilitates converting pricing information to be based upon any suitable parameter so that converted pricing information 1208 is based at least in part upon such parameters 1210.

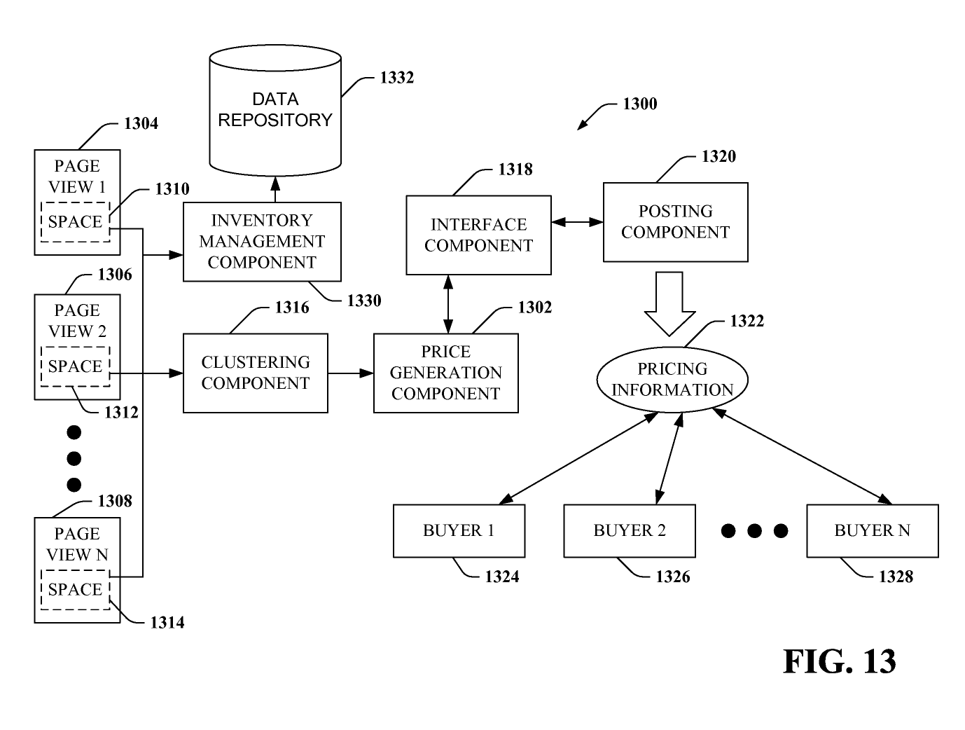

Turning now to FIG. 13, a system 1300 that facilitates sale of partial page views (e.g., advertising spaces) by way of a posted-price market is illustrated. The system 1300 includes a price generation component 1302 that is utilized to generate pricing information with respect to a plurality of page views 1304-1308 and a plurality of spaces 1310-1314 therein. As described above, the pricing information created by the price generation component 1302 can be based at least in part upon a percentage of page views in which a purchased space will display an advertisement associated with a purchaser. Furthermore, while each of the page views 1304-1308 is shown as including one space, it is understood that the page views 1304-1308 can each include a plurality of spaces.

The price generation component 1302 can be coupled to a clustering component 1316 that can cluster spaces together for pricing purposes. For example, spaces can be clustered based at least in part upon expected demand, location, information on a web page, or any other suitable manner. Further, it may be beneficial to cluster low-demand spaces so that prices of such spaces are not driven to zero. Upon receiving the clusters, the price generation component 1302 can provide pricing information to an interface component 1318, which is coupled to a posting component 1320. The posting component 1320 can post pricing information 1322 in a posted-price market so that it is available to a plurality of prospective buyers 1324-1328. One or more of the buyers 1324-1328 can then specify a quantity (e.g., in terms of percentages) that they desire to purchase.

As with any market, it is important to ensure that the seller is not overselling. In other words, the posting component 1320 should only post prices with respect to spaces that have not been sold out. An inventory management component 1330 can track sales of the spaces 1310-1314 and organize inventory within a data repository 1332. While not shown as such, the price generation component 1302 and the clustering component 1316 can access the data repository 1332 to aid in determining which spaces to cluster (e.g., clustering can be accomplished as a function of availability of the spaces 1310-1314), aid in determining demand, and aid in posting the pricing information 1322. Furthermore, the data repository 1332 can hold historical data relating to prior purchases, thereby enabling analysis of data therein to more accurately determine demand and thus drive the pricing information 1322 to a market equilibrium and/or revenue maximizing point.

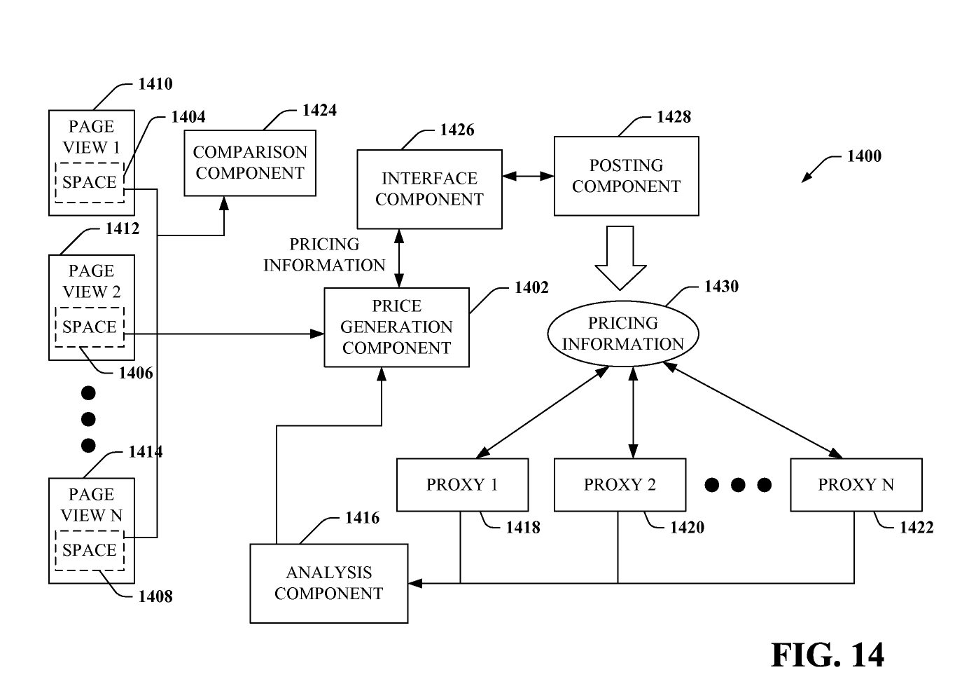

Now turning FIG. 14, a system 1400 that facilitates determining pricing information associated with a plurality of advertising spaces on a plurality of page views and selling such spaces in a posted-price market is illustrated. The system 1400 includes a price generation component 1402 that is employed to determine pricing information with respect to a plurality of spaces 1404-1408 associated with a plurality of page views 1410-1414. For instance, the price generation component 1402 can determine pricing information that relates to a percentage of page views in which a purchased advertisement will appear. The system 1400 further includes an analysis component 1416 that can analyze a plurality of proxies 1418-1422 that are associated with programmed demand curves of buyers represented by such proxies 1418-1422. For instance, the demand curves can be published, thereby enabling the analysis component 1416 to quickly determine a demand associated with particular spaces. In most instances, however, it is desirable for purchasers and sellers to not publish the demand curves associated with the proxies 1418-1422, as then such demand curves could be subject to fraud. Therefore, the analysis component 1416 can track activity of the proxies 1418-1422 to estimate demand of purchasers utilizing the proxies 1418-1422.

The system can further include a comparison component 1424 that is employed to compare spaces and/or sets of spaces that may be characterized as similar and adjust prices of at least one of the sets of spaces based at least in part upon the comparison. For instance, two similar spaces (e.g., spaces with similar positions, sizes, and on similar web sites) should not be associated with widely dissimilar prices. The comparison component 1424 can compare spaces and/or sets of spaces to further refine pricing information associated with the spaces 1404-1408. Upon price associated with the spaces 1404-1408 being determined, the price generation component 1402 can communicate with an interface component 1426, which can in turn communicate with a posting component 1428. The posting component 1428 can post pricing information 1430 in a posted-price market in a manner that purchases of the spaces 1404-1408 (or percentages associated therewith) can be effectuated by the proxies 1418-1422.

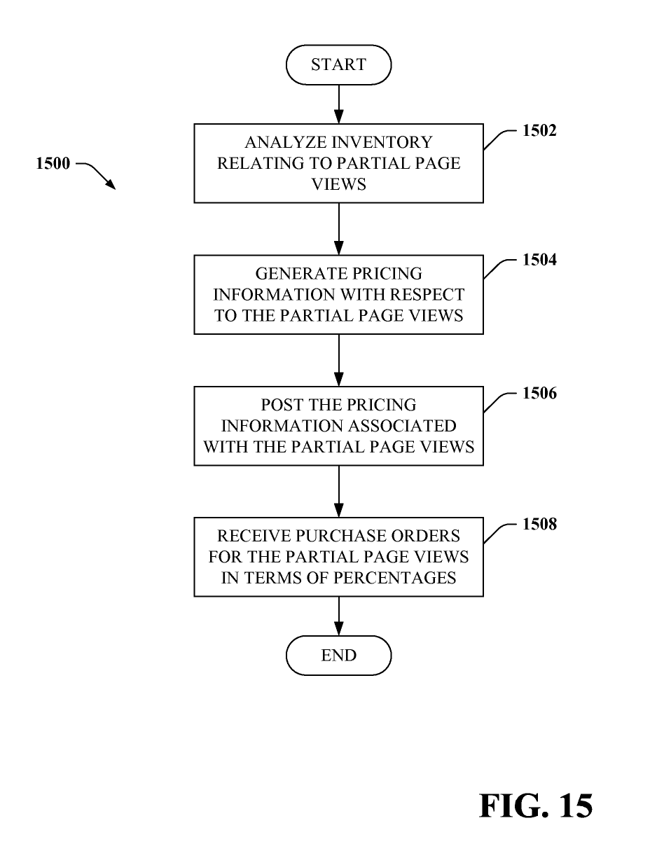

Turning now to FIG. 15, a methodology 1500 for creating a posted-price market with respect to partial page views is illustrated. At 1502, inventory relating to partial page views is analyzed. For instance, a data repository can be employed to store and organize inventory information, such as partial page views that are currently available for purchase, partial page views that are available for purchase at specific times in the future, options associated with partial page views, and any other data that may be relevant to inventory. Analyzing inventory is important as availability directly affects demand, which in turn affects price. Further, it is important not to sell more advertising space than what is available, as some countries associated treble damages when items are sold beyond availability. It is also important not to undersell the partial page views, as underselling can adversely affect revenue of the salesperson. Accordingly, a robust inventory system and analysis thereof can aid in effectuation of a posted-price market with respect to advertising space.

At 1504, pricing information is generated with respect to the partial page views. For example, the analysis of inventory can be utilized to assist in determining available supply of partial page views as well as demand for available partial page views. Pricing information can thereafter be generated based at least in part upon the supply and demand. Furthermore, the pricing information can be generated in a manner so that a purchaser isn't purchasing a certain number of impressions. Rather, the purchaser can be purchasing a percentage of page views in which an advertisement associated with the purchaser will appear. For example, the purchaser can purchase a percentage of partial page views associated with a search term or terms. Similarly, the purchaser can purchase a percentage of partial page views relating to a content page. In accordance with another aspect of the subject invention, the percentages associated with search terms can alter depending upon a location of the search term within a search. For example, the purchaser can receive a first percentage when a term is a sole term utilized in a search, a second percentage with a term is amongst a plurality of terms, a third percentage if the term is located at a beginning of a series of search terms, a fourth percentage if the term is located at an end of a series of search terms, etc. Thus, as can be discerned from this example, the pricing information can alter given disparate parameters associated with a search term.

At 1506, the pricing information generated at 1504 is posted in a manner so that a plurality of prospective buyers can review such information to determine whether to purchase one or more partial page views. For example, it can be posted so that proxies associated with the prospective buyers can utilize programmed demand curves to determine whether to purchase partial page views. The posting can be completed at any suitable location. At 1508, purchase orders are received for the partial page views in terms of the aforementioned percentages. The consummated sale can relate to a time in the future that the advertisements will be displayed, can include options associated with displaying advertisements, and the like. Thus, a futures market, an options market, a derivatives market, and the like is enabled through utilization of the methodology 1500.

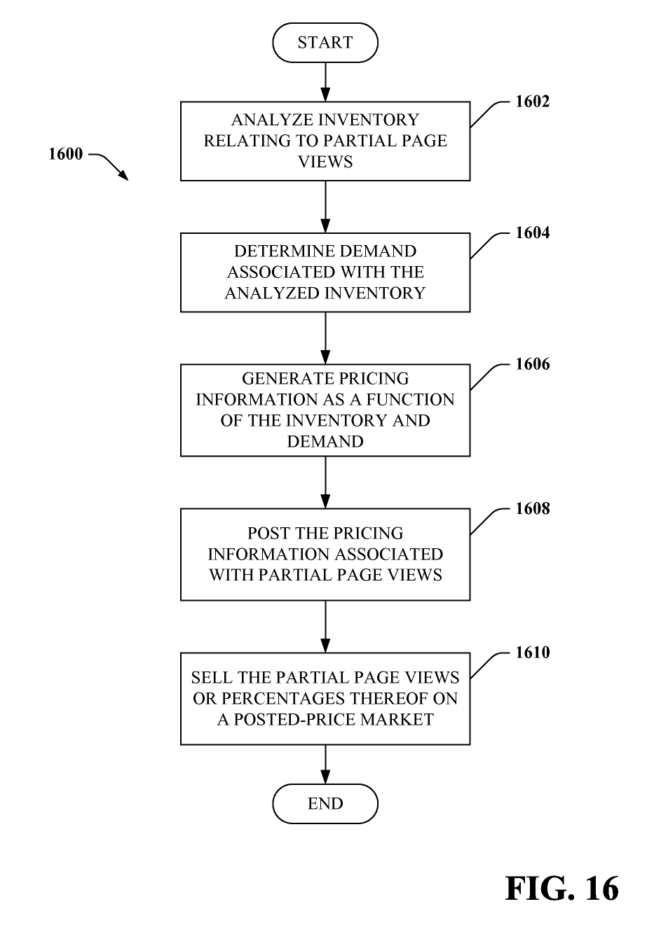

Now referring to FIG. 16, a methodology 1600 for implementing a posted-price market with respect to on-line advertisements is illustrated. At 1602, inventory is analyzed relating to partial page views. At 1604, demand associated with the analyzed inventory is determined. For example, a data repository that includes historical data relating to purchase of partial page views can be analyzed to estimate demand associated with such partial page views. Furthermore, demand curves of proxies may be made available, and thus demand can be determined by analyzing such demand curve. Any suitable determination/estimation of demand, however, is contemplated by the inventors of the subject invention and intended to fall under the scope of the hereto-appended claims.

At 1606, pricing information is generated as a function of the available inventory and the demand. Thus, a classical supply/demand analysis can be utilized in determining pricing information. The prices can be determined according to a strategy of a seller. For instance, if maximum revenue is desired, then supply can be artificially altered in order to maximize revenue. In a disparate strategy, market equilibrium may be desired—accordingly, supply may not be artificially altered (thus artificially affecting demand). At 1608, the pricing information associated with the partial page views is posted, and at 1610 the partial page views are offered for sale on a posted-price market. As described above, the market can be an options market, a futures market, a derivatives market, and the like.

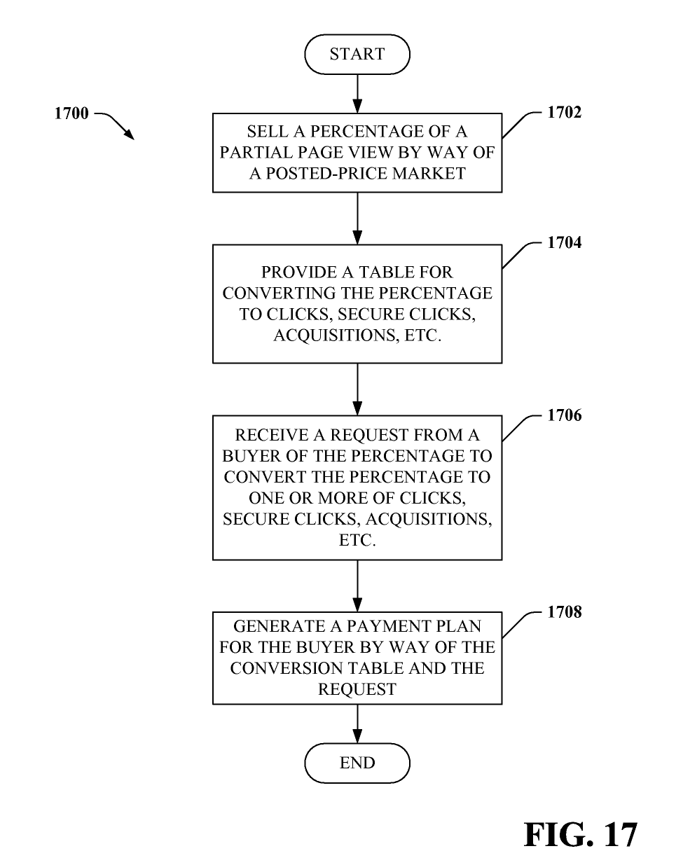

Turning now to FIG. 17, a methodology 1700 for converting pricing information with respect to a percentage of page views that will display an advertisement to a payment method preferred by a buyer. At 1702, a percentage of a partial page view is sold by way of a posted-price market. As described above, the percentage of the partial page view refers to a percentage of page views that will include an advertisement associated with a buyer. At the time of purchase, however, payment may not be finalized. Rather, the purchaser can opt for a payment plan based upon clicks, click through rate, secure clicks, acquisitions, and the like.

At 1704, a table is provided that enables conversion of the percentage into one or more of clicks, secure clicks, acquisitions, or any other suitable parameter. For instance, a price with respect to the percentage of the partial page view can be determined. It is desirable for the purchaser to provide payment for as near to the determined price as possible. Thus, for example, if the purchaser desires to pay based upon clicks, then an expected number of clicks can be calculated given the purchased percentage of the partial page view. Such information can be included within the conversion table, as well as conversions to various other payment options. Furthermore, as the purchased percentage of the partial page views can be subject to resale, conversion may not take place until implementation of the advertisement, as conversion factors will differ for disparate purchasers. At 1706, a request from a buyer to convert the percentage of the partial page views to payment based at least in part upon clicks, secure clicks, click through rate, and/or acquisitions is received, and at 1708 a payment plan is generated by way of the conversion table and the request. Accordingly, the seller will receive approximately the same revenue as if the conversion had not taken place, and the buyer will be able to select a payment plan of their choice.

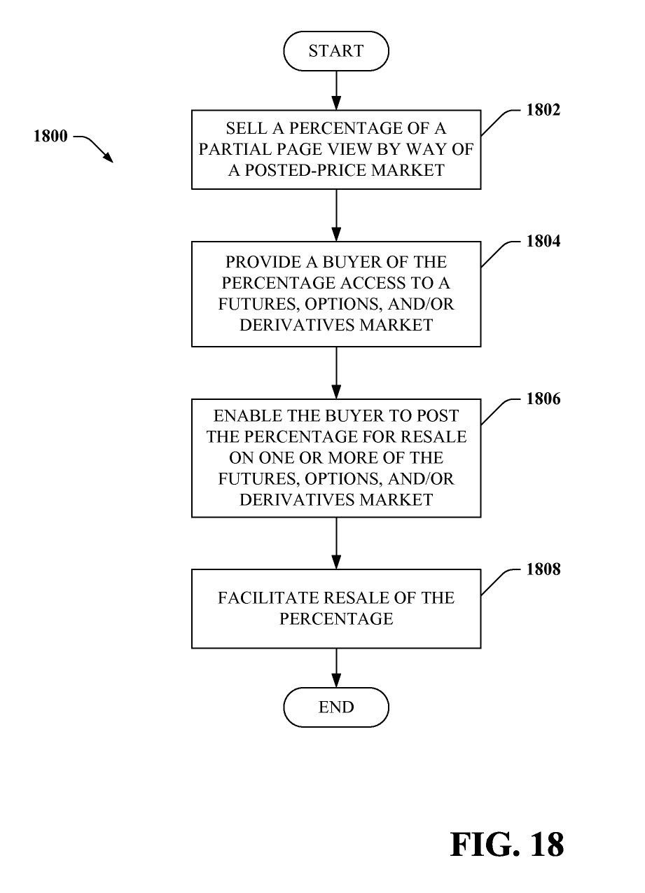

Now referring to FIG. 18, a methodology for selling and re-selling on-line advertising space is illustrated. At 1802, a percentage of a partial page view is sold by way of a posted-price market. At 1804, a buyer of such percentage is provided with access to a futures, options, and/or derivatives market. At 1806, the buyer is enabled to post the percentage for resale on one or more of the futures, options, and/or derivatives market, depending upon a type of item originally purchased. At 1808, resale of the percentage is facilitated within such market. Thus, utilizing one or more aspects of the subject invention, advertisers can view buying and selling of advertising space as both an investment in advertising as well as a conventional financial investment. Thus, if a prospective purchaser speculates that certain search terms will be employed with greater frequency at a future point in time, such prospective purchaser can purchase advertising space by way of a futures contract.

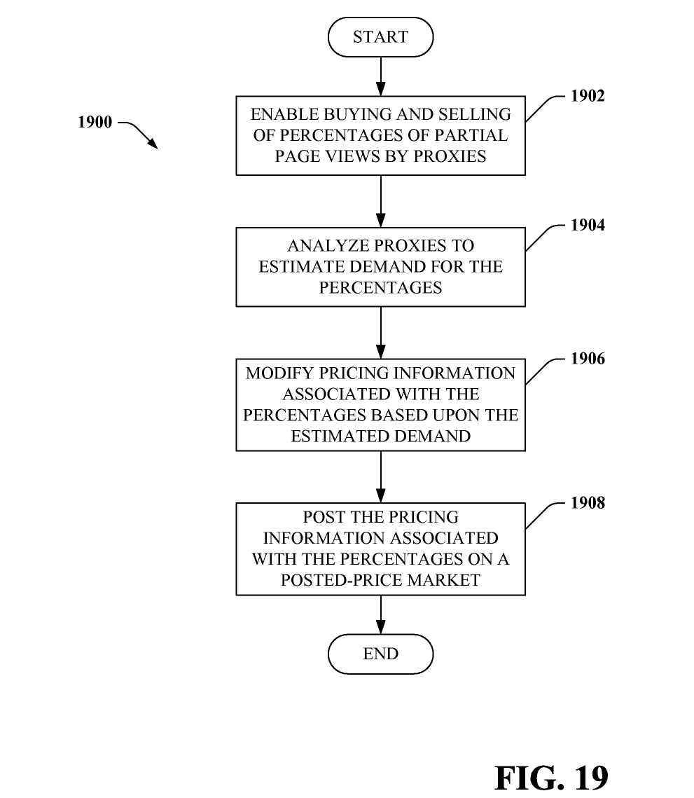

Turning now to FIG. 19, a methodology 1900 for determining pricing information associated with on-line advertising space is illustrated. At 1902, buying and selling of percentages of partial page views by proxies is illustrated. For example, proxies structured in a manner that enables use of a demand curve to purchase advertising space and that further include authority to buy and sell advertising space can be employed in accordance with the subject invention. The demand curve can be published or encrypted within a proxy module. At 1904, the proxies are analyzed to estimate demand for the percentages of the partial page views. For instance, if the demand curve associated with the proxies is published, then demand for particular search terms can quickly be determined. If, however, the demand curves are encrypted, then analysis over time may be necessary to obtain an accurate estimate of demand. At 1906, pricing information of the percentages of the partial page views is modified based upon the estimated demand, and at 1908 the pricing information is posted on a posted-price market.

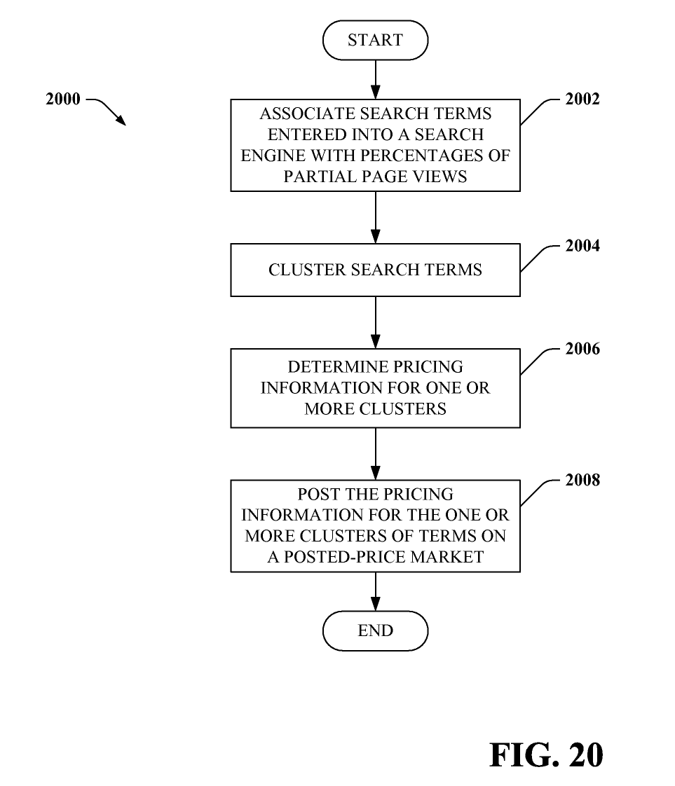

Turning now to FIG. 20, a methodology 2000 for pricing percentages of partial page views is illustrated. At 2002, search terms that can be entered into a search engine are associated with partial page views in general, and more specifically associated with percentages of the partial page views in which advertisement space can be purchased. For instance, it may be desirable to sell a first search term in percentage packages of ten percent, while it may be desirable to sell a second search term in percentage packages of five percent. At 2004, search terms are clustered in accordance with any suitable parameter. For instance, terms can be clustered according to demand, according to type, or any other suitable parameter. At 2006, pricing information is determined for one or more of the clusters, and at 2008 the pricing information for the one or more clusters is posted on a posted-price market. Such clustering and pricing of clusters (rather than individual search terms) can enhance efficiency of a market.

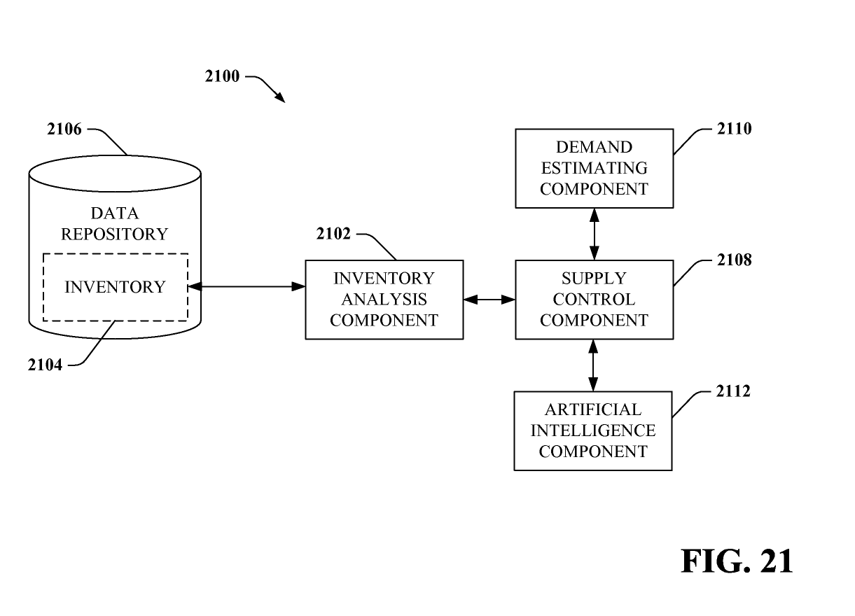

Now referring to FIG. 21, a system 2100 that facilitates artificially controlling supply (and thus controlling demand) with respect to on-line advertising space is illustrated. The system 2100 includes an inventory analysis component 2102 that analyzes inventory 2104 or records of inventory within a data repository 2106. For instance, the inventory analysis component 2102 can determine particular trending information associated with purchases of on-line advertising space, review remaining spaces and calculate probabilities associated with sale of such spaces at current prices, probabilities of sale associated with disparate price ranges, and other suitable analysis. The system 2100 can further include a supply control component 2108 that can alter supply to comport with a market strategy. For instance, to maximize revenue, instances will exist that it is more profitable long term not to sell certain spaces than it is to sell the spaces at low cost. Thus, the supply control component 2108 can limit supply to maximize revenue if desired. The supply component 2108 can later provide supply if a greater demand for particular spaces is estimated/determined.

Demand can be estimated by a demand estimating component 2110. While not shown as such, the demand estimating component 2110 can be directly coupled to the data repository 2106, which can include data relating to past sales of on-line advertising space. The historic data can be analyzed to estimate a current demand. The supply control component 2108 can further be associated with an artificial intelligence component 2112 that can generate inferences relating to altering supply of on-line advertising space provided for sale on a posted-price market. For a particular example, the artificial intelligence component 2112 can monitor fluctuations in supply and fluctuations in revenue over time, and make inferences to correct market anomalies that may exist with respect to such fluctuations. For example, the artificial intelligence component 2112 can determine that particular search terms are utilized with high frequency seasonally, and are employed with low frequency outside of such frequency. Accordingly, demand for advertisements associated with search pages that result from utilization of the term in a search engine are low when frequency of utilization of the term is low. To maximize revenue and maintain sufficient demand for advertisements associated with the term, supply of advertising spaces associated with the term can be limited except for when such term is utilized with high frequency.

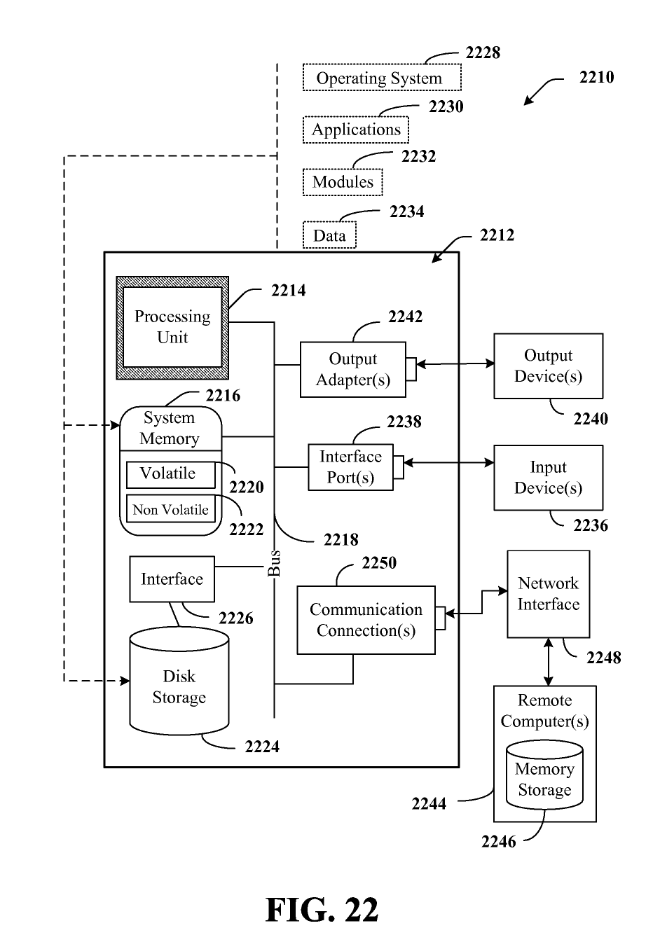

In order to provide additional context for various aspects of the claimed subject matter, FIG. 22 and the following discussion are intended to provide a brief, general description of a suitable operating environment 2210 in which various aspects of the claimed subject matter may be implemented. While the claimed subject matter is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 2210 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 22, an exemplary environment 2210 for implementing various aspects of the claimed subject matter, such as selling percentages of impressions with respect to one or more keywords, includes a computer 2212. The computer 2212 includes a processing unit 2214, a system memory 2216, and a system bus 2218. The system bus 2218 couples system components including, but not limited to, the system memory 2216 to the processing unit 2214. The processing unit 2214 can be any of various available processors. Dual microprocessors and other multiprocessor architectures also can be employed as the processing unit 2214.

The system bus 2218 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI). The system memory 2216 includes volatile memory 2220 and nonvolatile memory 2222. The basic input/output system (BIOS), containing the basic routines to transfer information between elements within the computer 2212, such as during start-up, is stored in nonvolatile memory 2222. By way of illustration, and not limitation, nonvolatile memory 2222 can include read only memory (ROM), programmable ROM (PROM), electrically programmable ROM (EPROM), electrically erasable ROM (EEPROM), or flash memory. Volatile memory 2220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2212 also includes removable/nonremovable, volatile/nonvolatile computer storage media. FIG. 22 illustrates, for example a disk storage 2224. Disk storage 2224 includes, but is not limited to, devices like a magnetic disk drive, floppy disk drive, tape drive, Jaz drive, Zip drive, LS-100 drive, flash memory card, or memory stick. In addition, disk storage 2224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 2224 to the system bus 2218, a removable or non-removable interface is typically used such as interface 2226.

It is to be appreciated that FIG. 22 describes software that acts as an intermediary between users and the basic computer resources described in suitable operating environment 2210. Such software includes an operating system 2228. Operating system 2228, which can be stored on disk storage 2224, acts to control and allocate resources of the computer system 2212. System applications 2230 take advantage of the management of resources by operating system 2228 through program modules 2232 and program data 2234 stored either in system memory 2216 or on disk storage 2224. It is to be appreciated that the claimed subject matter can be implemented with various operating systems or combinations of operating systems.

A user enters commands or information into the computer 2212 through input device(s) 2236. Input devices 2236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2214 through the system bus 2218 via interface port(s) 2238. Interface port(s) 2238 include, for example, a serial port, a parallel port, a game port, and a universal serial bus (USB). Output device(s) 2240 use some of the same type of ports as input device(s) 2236. Thus, for example, a USB port may be used to provide input to computer 2212, and to output information from computer 2212 to an output device 2240. Output adapter 2242 is provided to illustrate that there are some output devices 2240 like monitors, speakers, and printers among other output devices 2240 that require special adapters. The output adapters 2242 include, by way of illustration and not limitation, video and sound cards that provide a means of connection between the output device 2240 and the system bus 2218. It should be noted that other devices and/or systems of devices provide both input and output capabilities such as remote computer(s) 2244.

Computer 2212 can operate in a networked environment using logical connections to one or more remote computers, such as remote computer(s) 2244. The remote computer(s) 2244 can be a personal computer, a server, a router, a network PC, a workstation, a microprocessor based appliance, a peer device or other common network node and the like, and typically includes many or all of the elements described relative to computer 2212. For purposes of brevity, only a memory storage device 2246 is illustrated with remote computer(s) 2244. Remote computer(s) 2244 is logically connected to computer 2212 through a network interface 2248 and then physically connected via communication connection 2250. Network interface 2248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2250 refers to the hardware/software employed to connect the network interface 2248 to the bus 2218. While communication connection 2250 is shown for illustrative clarity inside computer 2212, it can also be external to computer 2212. The hardware/software necessary for connection to the network interface 2248 includes, for exemplary purposes only, internal and external technologies such as, modems including regular telephone grade modems, cable modems and DSL modems, ISDN adapters, and Ethernet cards.

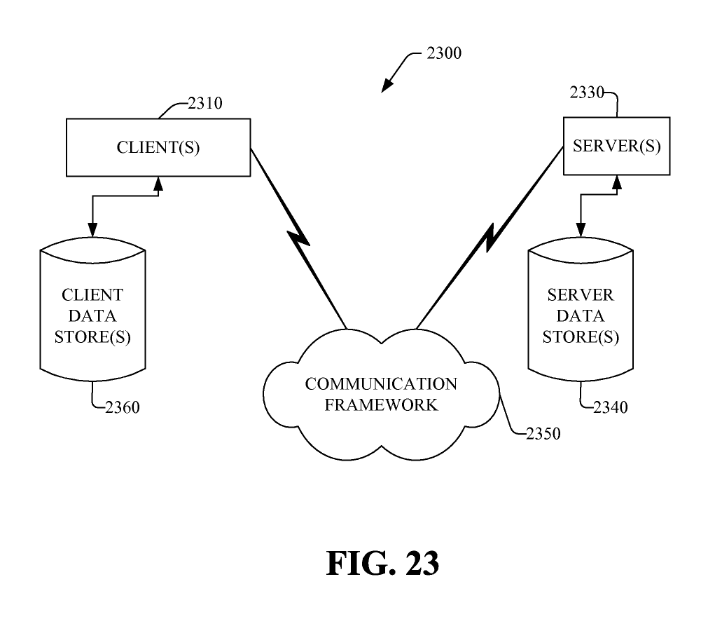

FIG. 23 is a schematic block diagram of a sample-computing environment 2300 with which the claimed subject matter can interact. The system 2300 includes one or more client(s) 2310. The client(s) 2310 can be hardware and/or software (e.g., threads, processes, computing devices). The system 2300 also includes one or more server(s) 2330. The server(s) 2330 can also be hardware and/or software (e.g., threads, processes, computing devices). The servers 2330 can house threads to perform transformations by employing the subject invention, for example. One possible communication between a client 2310 and a server 2330 can be in the form of a data packet adapted to be transmitted between two or more computer processes. The system 2300 includes a communication framework 2350 that can be employed to facilitate communications between the client(s) 2310 and the server(s) 2330. The client(s) 2310 are operably connected to one or more client data store(s) 2360 that can be employed to store information local to the client(s) 2310. Similarly, the server(s) 2330 are operably connected to one or more server data store(s) 2340 that can be employed to store information local to the servers 2330.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An advertisement sales system comprising the following computer executable components:
a receiver component that receives a request to purchase impressions on at least one of web pages and application programs based at least in part on one of an exact and approximate keyword match; and
a sales component that sells a percentage of all such impressions to an initiator of the request.

2. The system of claim 1, the impressions are displayed in conjunction with search results.

3. The system of claim 1, the impressions are displayed on third party web pages not controlled by a seller of the percentage of the impressions.

4. The system of claim 3, keywords are detected on the third party web page and utilized for a keyword match.

5. The system of claim 1, further comprising a randomizer that is employed to determine an advertisement to display amongst a plurality of advertisements upon receipt of a keyword.

6. The system of claim 1, an approximate keyword match is a match of one of a prefix and a suffix of a phrase.

7. The system of claim 1, the request to purchase is additionally based at least in part upon one or more of location, time of day, gender, IP-address, age, and behavior categorization of a viewer.

8. The system of claim 1, the sales component additionally sells impressions on one or more of a pay-per-click and a pay-per-impression basis in combination with selling advertising views on a pay-per-percentage basis.

9. The system of claim 1, further comprising a price setting component that is utilized to set a price with respect to the percentage of impressions.

10. The system of claim 9, the price generation component utilizes an auction to set the price with respect to the percentage of impressions.

11. The system of claim 1, further comprising an auctioning component that conducts an auction in connection with selling the percentage of impressions.

12. The system of claim 11, further comprising a revenue maximization component that combines bids received by the auctioning component to maximize revenue.

13. A computer-implemented method for selling advertising views on web pages or application programs comprising the following computer-executable acts:
receiving a request to purchase advertising views associated with a keyword; and
selling a percentage of all such advertising views meeting predefined criteria by way of an auction.

14. The method of claim 13, the predefined criteria include at least one of location, time-of-day, gender, IP-address, age or behavioral categorization of the viewer, and the presence or absence of at least a portion of a URL in a web page.

15. The method of claim 13, further comprising displaying the advertising views in conjunction with search results.

16. The method of claim 13, the criteria includes at least one of an exact match and a broad match criterion.

17. The method of claim 13, further comprising combining bids within the auction to maximize revenue.

18. The method of claim 13, the percentage of impressions are sold for one of a one day period, a one week period, and a one month period.

19. The method of claim 13, further comprising randomly displaying one of the advertising views when the keyword is received at a search engine.

20. A system for selling impressions, comprising:
computer-executable means for receiving a request to purchase a percentage of impressions with respect to a keyword; and
computer-executable means for selling the percentage of impressions by way of auction to an initiator of the request.
